(19) United States
(12) Patent Application Publication
(10) Pub. No.: US 2021/0143916 A1
(43) Pub. Date: May 13, 2021

(54) DEVICE CONTROL THROUGH ULTRASONIC COMMUNICATION

(71) Applicant: CARRIER CORPORATION, Pajm Beach Garden, FL (US)

(72) Inventors: Guru Charan Kottur, Hyderabad, Telangana (IN); Srinivasa Rao Ladi, Hyderabad, Telangana (IN)

(21) Appl. No.: 17/256,850

(22) PCT Filed: Jun. 3, 2019
(86) PCT No.: PCT/US2019/035131

§ 371 Date: Dec. 29, 2020

(30) Foreign Application Priority Data
Jun. 30, 2018 (IN) 201811024465

(51) Int. Cl. H04B 11/00; F24F 11/56; F24F 11/88

(52) U.S. Cl. CPC H04B 11/00; F24F 11/88; F24F 11/56

(57) ABSTRACT

A method of controlling operation of a device using ultrasonic soundwaves is provided. The method including: detecting an ultrasonic sound wave transmitted from a speaker of a mobile device; decrypting the ultrasonic sound wave transmitted from the speaker; determining a command from the decrypted ultrasonic sound; and adjusting operation of the device in response to the command.

### BACKGROUND

The embodiments herein relate to the field of wireless connection for command and control of devices, and specifically to a method and apparatus for wirelessly connecting to a device using soundwaves for command and control of devices.

Conventional devices typically communicate with a mobile application over a Wi-Fi network. However the devices may be embedded inside a panel or inaccessible location, which may make Wi-Fi connection difficult due to weak signal strength.

### BRIEF SUMMARY

According to an embodiment, a method of controlling operation of a device using ultrasonic soundwaves is provided. The method including: detecting an ultrasonic sound wave transmitted from a speaker of a mobile device; decrypting the ultrasonic sound wave transmitted from the speaker; determining a command from the decrypted ultrasonic sound; and adjusting operation of the device in response to the command.

In addition to one or more of the features described herein, or as an alternative, further embodiments may include that the ultrasonic sound wave is within a range of about 20 MHz.

In addition to one or more of the features described herein, or as an alternative, further embodiments may include that the device is a lock and the adjusting operation of the device in response to the command includes actuating a locking mechanism of the lock.

In addition to one or more of the features described herein, or as an alternative, further embodiments may include that the device is an HVAC system and the adjusting operation of the device in response to the command includes adjusting a compressor, fan, or furnace of the HVAC system.

In addition to one or more of the features described herein, or as an alternative, further embodiments may include that the device is an embedded device located in an area inaccessible to Wi-Fi.

In addition to one or more of the features described herein, or as an alternative, further embodiments may include that prior to detecting an ultrasonic sound wave transmitted from a speaker of a mobile device, the method further includes: detecting a failure of a primary means of communication between the device and a mobile device.

In addition to one or more of the features described herein, or as an alternative, further embodiments may include that adjusting operation of the device in response to the command includes updating a configuration of the device.

According to another embodiment, a device for use in ultrasonic communication system is provided. The device including: a microphone configured to detect an ultrasonic sound wave transmitted from a speaker of a mobile device; a processor configured to decrypt the ultrasonic sound wave transmitted from the speaker, determine a command from the decrypted ultrasonic sound, and adjust operation of the device in response to the command.

In addition to one or more of the features described herein, or as an alternative, further embodiments may include that the ultrasonic sound wave is within a range of about 20 MHz.

In addition to one or more of the features described herein, or as an alternative, further embodiments may include that the device is a lock and a locking mechanism of the lock is adjusted in response to the command.

In addition to one or more of the features described herein, or as an alternative, further embodiments may include that the device is an HVAC system and a compressor, fan, or furnace of the HVAC system is adjusted in response to the command.

In addition to one or more of the features described herein, or as an alternative, further embodiments may include that the device is an embedded device located in an area inaccessible to Wi-Fi.

In addition to one or more of the features described herein, or as an alternative, further embodiments may include that the microphone configured to detect an ultrasonic sound wave only after the device has detected a failure of a primary means of communication between the device and the mobile device.

In addition to one or more of the features described herein, or as an alternative, further embodiments may include that the configuration of the device is updated in response to the command.

According to another embodiment, a computer program product tangibly embodied on a computer readable medium is provided. The computer program product including instructions that, when executed by a processor, cause the processor to perform operations including: detecting an ultrasonic sound wave transmitted from a speaker of a mobile device; decrypting the ultrasonic sound wave transmitted from the speaker; determining a command from the decrypted ultrasonic sound; and adjusting operation of the device in response to the command.

In addition to one or more of the features described herein, or as an alternative, further embodiments may include that the ultrasonic sound wave is within a range of about 20 MHz.

In addition to one or more of the features described herein, or as an alternative, further embodiments may include that the device is a lock and the adjusting operation of the device in response to the command includes actuating a locking mechanism of the lock.

In addition to one or more of the features described herein, or as an alternative, further embodiments may include that the device is an HVAC system and the adjusting operation of the device in response to the command includes adjusting a compressor, fan, or furnace of the HVAC system.

In addition to one or more of the features described herein, or as an alternative, further embodiments may include that the device is an embedded device located in an area inaccessible to Wi-Fi.

In addition to one or more of the features described herein, or as an alternative, further embodiments may include that prior to detecting an ultrasonic sound wave transmitted from a speaker of a mobile device, the operations further includes: detecting a failure of a primary means of communication between the device and a mobile device.

Technical effects of embodiments of the present disclosure include utilizing ultrasonic sound waves for wireless command and control of a device.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an ultrasonic communication system, in accordance with an embodiment of the present disclosure; and

FIG. 2 is a flow chart of a method of controlling operation of a device using ultrasonic soundwaves, in accordance with an embodiment of the disclosure.

### DETAILED DESCRIPTION

FIG. 1 illustrates a block diagram of an ultrasonic communication system 10 configured to transmit data 92 between a mobile device 12 and a device 60 using ultrasonic sound waves 92. It should be appreciated that, although particular systems are separately defined in the schematic block diagram of FIG. 1, each or any of the systems may be otherwise combined or separated via hardware and/or software. The device 60 may be an embedded device located deep within a building system component in a non-limiting example. The embedded device may be mounted either inside a panel or place inaccessible, thus making it difficult to connect over Wi-Fi due to weak signal strength. For example, an embedded device may be a controller of an elevator system inside a control panel, a controller of a heating ventilation, and air conditioning (HVAC) system inside of a control panel, or a fire and security system inside of a control panel. The embedded device may be capable of communication with external communication devices including mobile phones, computing clouds, and other sensors.

The mobile device 12 may be a mobile computing device that is typically carried by a person, such as, for example a smartphone, PDA, smartwatch, tablet, laptop, or any other mobile computing device known to one of skill in the art. As shown in FIG. 1, the mobile device 12 generally includes an antenna 40, a transceiver 42, a processor 44, a memory 46, a GPS receiver 48, an input device 50, an output device 52, a power supply 54, a microphone 57, and a speaker 58. The transceiver 42 is a transceiver of a type corresponding to a wireless transceiver (e.g., cellular), and the antenna 40 is a corresponding antenna. The mobile devices includes a processor 44 and an associated memory 46 comprising computer-executable instructions that, when executed by the processor 44, cause the processor 44 to perform various operations. The processor 44 may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 46 may be a storage device, such as, for example, a random access memory (RAM), read only memory (ROM), or other electronic, optical, magnetic or any other computer readable medium. The mobile device 12 may also include a mobile device application 80. Embodiments disclosed herein, may operate through the mobile device application 80 installed on the mobile device 12. The input device 50 may be a device capable of inputting data to the mobile device 12 such as, for example, a touch screen, key board, or any other input device known to one of skill in the art. The output device 52 may be a device capable of outputting data from the mobile device 12 such as, for example, a touch screen, display screen or any other input device known to one of skill in the art.

The power supply 54 of the mobile device 12 is configured to store and/or supply electrical power to the mobile device 12. In an embodiment, the power supply 54 may be a self-contained unit within the mobile device 12 configured to store and/or generate electricity to power the device 60. The power supply 54 may include an energy storage system, such as, for example, a battery system, capacitor, or other energy storage system known to one of skill in the art. The power supply 54 may also generate electrical power for the device 60. The power supply 54 may also include an energy generation or electricity harvesting system, such as, for example synchronous generator, induction generator, or other type of electrical generator known to one of skill in the art.

The mobile device 12 also includes a speaker 57 and a microphone 57. The speaker 58 is configured to generate ultrasonic sound waves 90 to transmit data 92 to a microphone 66 of the device 60. It is understood, that the speaker 57 may generate other sound waves other than ultrasonic sound waves 90. The microphone 57 is configured to detect ultrasonic sound waves 90 transmitting data 92 from a speaker 68 of the device 60. It is understood, that the microphone 57 may detect other sound waves other than ultrasonic sound waves 90.

In an embodiment, the ultrasonic sound waves 90 may be in the range of about 20 MHz. In another embodiment, the ultrasonic sound wave 90 may utilize Audio QR Utilizing the application 80 on the mobile device 12, the processor 44 may be configured to encrypt the data 92 prior to transmitting the data 92 through the speaker 58 as ultrasonic sound waves 90 to the device 60. Utilizing the application 80 on the mobile device 12, the processor 44 may be configured to decrypt the data 92 once it is detected by the microphone 57 as ultrasonic sound waves 90 from device 60.

The device 60 may be a building system, such as, for example, an HVAC system, an elevator system, fire alarm system, a security system, a video camera system, a light, lock, a door lock or any other building system known to one of skill in the art. As shown in FIG. 1, the device 60 generally includes a controller 62, a power supply 64, a microphone 66, and a speaker 68. The controller 62 controls the operation of the device 60 and may include a processor 72 and an associated memory 74 comprising computer-executable instructions that, when executed by the processor 72, cause the processor 72 to perform various operations. The processor 72 may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 74 may be a storage device, such as, for example, a random access memory (RAM), read only memory (ROM), or other electronic, optical, magnetic or any other computer readable medium.

The power supply 64 of the device 60 is configured to store and/or supply electrical power to the device 60. In one embodiment, the power supply 64 may be an electrical outlet that device plugs into. In another embodiment, the power supply 64 may be a self-contained unit within the device 60 configured to store and/or generate electricity to power the device 60. The power supply 64 may include an energy storage system, such as, for example, a battery system, capacitor, or other energy storage system known to one of skill in the art. The power supply 64 may also generate electrical power for the device 60. The power supply 64 may also include an energy generation or electricity harvesting system, such as, for example synchronous generator, induction generator, or other type of electrical generator known to one of skill in the art.

The device 60 also includes a speaker 68 and a microphone 66. The speaker 68 is configured to generate ultrasonic sound waves 90 to transmit data 92 to a microphone 57 of the mobile device 12. It is understood, that the speaker 68 may generate other sound waves other than ultrasonic sound waves 90. The microphone 66 is configured to detect ultrasonic sound waves 90 transmitting data 92 from a speaker 58 of the mobile device 12. It is understood, that the microphone 66 may detect other sound waves other than ultrasonic sound waves 90.

The processor 72 may be configured to encrypt the data 92 prior to transmitting the data 92 through the speaker 68 as ultrasonic sound waves 90 to the mobile device 12. Also, the processor 72 may be configured to decrypt the data 92 once it is detected by the microphone 66 as ultrasonic sound waves 90 from mobile device.

The data 92 may include a command to the device 60 to adjust the device 60 by adjusting a device component 80. For example, the device 60 may be an HVAC system and the device component 80 may be the compressor, fan, or furnace of the HVAC system. In another example, the device component 80 may be a locking mechanism and the device 60 may be a lock. In additional examples, the device components 80 may be software configuration files, a process, LEDS, a sensor, an interface (e.g., serial port), an Ethernet interface, etc.

Referring now to FIG. 2, while referencing components of FIG. 1. FIG. 2 shows a flow chart of a method 200 of controlling operation of a device 60 using ultrasonic soundwaves 90, in accordance with an embodiment of the disclosure. Ultrasonic soundwaves 90 may be utilized as a primary means of communication method between a device 60 and a mobile device 12 or as a secondary means of communication between a device 60 and a mobile device 12. For example, if the ultrasonic soundwaves 90 are being used as a secondary means of communication then method 200 may be prompted by a failure of the primary means of communication between the device 60 and the mobile device 12. In furtherance of that example, an additional step in method 200 may exist prior to block 204 that includes “detecting a failure of a primary means of communication between the device 60 and a mobile device 12.”

At block 204, an ultrasonic sound wave 90 transmitted from a speaker 58 of a mobile device 12 is detected by a microphone 66 of the device 60. In an embodiment, the device 60 is an embedded device located in an area inaccessible to Wi-Fi. At block 206, the ultrasonic sound wave 90 transmitted from the speaker 58 is decrypted by the processor 72 of the device 60. In an embodiment, the ultrasonic sound wave 90 is within a range of about 20 MHz. At block 208, a command from the decrypted ultrasonic sound wave 90 is determined by the processor 72 of the device 60. The command is contained in data 92 transmitted in the ultrasonic sound wave 90. At block 210, operation of the device 60 is adjusted in response to the command. In an embodiment, the device 60 is a lock and a locking mechanism of the lock is adjusted in response to the command. In another embodiment, the device 60 is an HVAC system and a compressor, fan, or furnace of the HVAC system is adjusted in response to the command. In an embodiment, the command may be a configuration update for the device 60, and thus the configuration of the device 60 may be updated in response to the command.

While the above description has described the flow process of FIG. 2 in a particular order, it should be appreciated that unless otherwise specifically required in the attached claims that the ordering of the steps may be varied.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A method of controlling operation of a device using ultrasonic soundwaves, the method comprising:
detecting an ultrasonic sound wave transmitted from a speaker of a mobile device;
decrypting the ultrasonic sound wave transmitted from the speaker;
determining a command from the decrypted ultrasonic sound; and
adjusting operation of the device in response to the command.

2. The method of claim 1, wherein the ultrasonic sound wave is within a range of about 20 MHz.

3. The device of claim 1, wherein the device is a lock and the adjusting operation of the device in response to the command includes actuating a locking mechanism of the lock.

4. The method of claim 1, wherein the device is an HVAC system and the adjusting operation of the device in response to the command includes adjusting a compressor, fan, or furnace of the HVAC system.

5. The method of claim 1, wherein the device is an embedded device located in an area inaccessible to Wi-Fi.

6. The method of claim 1, wherein prior to detecting an ultrasonic sound wave transmitted from a speaker of a mobile device, the method further comprises:
detecting a failure of a primary means of communication between the device and a mobile device.

7. The method of claim 1, wherein adjusting operation of the device in response to the command includes updating a configuration of the device.

8. A device for use in ultrasonic communication system, comprising:
a microphone configured to detect an ultrasonic sound wave transmitted from a speaker of a mobile device;
a processor configured to decrypt the ultrasonic sound wave transmitted from the speaker, determine a command from the decrypted ultrasonic sound, and adjust operation of the device in response to the command.

9. The device of claim 8, wherein the ultrasonic sound wave is within a range of about 20 MHz.

10. The device of claim 8, wherein the device is a lock and a locking mechanism of the lock is adjusted in response to the command.

11. The device of claim 8, wherein the device is an HVAC system and a compressor, fan, or furnace of the HVAC system is adjusted in response to the command.

12. The device of claim 8, wherein the device is an embedded device located in an area inaccessible to Wi-Fi.

13. The device of claim 8, wherein the microphone configured to detect an ultrasonic sound wave only after the device has detected a failure of a primary means of communication between the device and the mobile device.

14. The device of claim 8, wherein the configuration of the device is updated in response to the command.

15. A computer program product tangibly embodied on a computer readable medium, the computer program product including instructions that, when executed by a processor, cause the processor to perform operations comprising:
detecting an ultrasonic sound wave transmitted from a speaker of a mobile device;
decrypting the ultrasonic sound wave transmitted from the speaker;
determining a command from the decrypted ultrasonic sound; and
adjusting operation of the device in response to the command.

16. The computer program product of claim 15, wherein the ultrasonic sound wave is within a range of about 20 MHz.

17. The computer program product of claim 15, wherein the device is a lock and the adjusting operation of the device in response to the command includes actuating a locking mechanism of the lock.

18. The computer program product of claim 15, wherein the device is an HVAC system and the adjusting operation of the device in response to the command includes adjusting a compressor, fan, or furnace of the HVAC system.

19. The computer program product of claim 15, wherein the device is an embedded device located in an area inaccessible to Wi-Fi.

20. The computer program product of claim 15, wherein prior to detecting an ultrasonic sound wave transmitted from a speaker of a mobile device, the operations further comprises:
detecting a failure of a primary means of communication between the device and a mobile device.
